(19) United States
(12) Patent Application Publication
(10) Pub. No.: US 2007/0052555 A1
(43) Pub. Date: Mar. 8, 2007

(54) Predictive adaptive front lighting integrated system

(75) Inventor: Faroog Abdel-Kareem Ibrahim, Dearborn Heights, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/222,056

(22) Filed: Sep. 8, 2005

(51) Int. Cl. G08G 1/123

(52) U.S. Cl. 340/990

(57) ABSTRACT

An adaptive front lighting system includes a navigation system and a control module. The navigation system determines the curvature of the road ahead of the vehicle, and the control module receives information about the curvature of the road ahead of the vehicle and instructs the headlamps to swivel over a swivel angle to illuminate the roadway ahead of the vehicle.

### BACKGROUND

The present invention generally relates to adaptive front lighting systems for vehicles.

Recently, adaptive front lighting systems have been implemented in certain passenger and commercial vehicles. Conventional adaptive front lighting systems use various parameters such as the steering angle and vehicle speed of the vehicle as data to estimate the desired swiveling angle of the vehicle's headlamps as the vehicle maneuvers along a road. However, these adaptive front lighting systems typically employ the instantaneous steering angle and vehicle speed data (that is, the value of the data at the vehicle's current position) to swivel the headlamps. Therefore, such conventional system are unable to predict changes in the road geometry ahead of the vehicle.

Moreover, jitter typically occurs in the steering angle measurements as the driver keeps the vehicle in the driving lane by constantly adjusting the steering wheel about its dead zone. Hence, adaptive front lighting systems commonly employ filters to remove the jitter. These filtering operations, however, produce a delay in the adjustments of the swivel angle of the headlamps.

In view of the above, it is apparent that there exists a need for adaptive front lighting systems that are able to predict the road geometry ahead of the vehicle and to minimize or eliminate jitter in steering angle measurements.

### SUMMARY

In satisfying the above need, as well as overcoming the enumerated drawbacks and other limitations of the related art, the present invention provides an adaptive front lighting system that is able to predict changes in the road geometry ahead of a vehicle and to aim the vehicle's headlamps along the road.

In a general aspect, the adaptive front lighting system includes a navigation system and a control module. The navigation system determines the curvature of the road ahead of the vehicle, and the control module receives information about the curvature of the road ahead of the vehicle and instructs the headlamps to swivel over a swivel angle to illuminate the roadway ahead of the vehicle.

In particular implementations, the adaptive front lighting system includes a fusion module that processes the curvature information from the navigation system, calculates the swivel angle for the headlamps, and transmits the calculated swivel angle to the control module. The adaptive front lighting system may also include a lane detection module that detects, tracks, and recognizes lane boundaries and passes this information to the navigation system to aid determining a most likely path of the vehicle.

In certain implementations, the navigation system includes a vehicle positioning and path prediction module that communicates with the fusion module. The vehicle positioning and path prediction module determines the vehicle's position in a global positioning system, determines the vehicle's position on a map based on the position in the global positioning system, and looks ahead on the map for curves and determines the most likely path through the curves.

Further features and advantages of the invention will be apparent from the following description, and from the claims.

### BRIEF DESCRIPTION OF THE DRAWINGS

FIG. 1 shows various scenarios encountered by a convention adaptive front lighting system.

FIG. 2 is a block diagram of a system for determining the most likely path of a vehicle.

FIG. 3 is a block diagram of a system for predictive adaptive front lighting in accordance with the invention.

### DETAILED DESCRIPTION

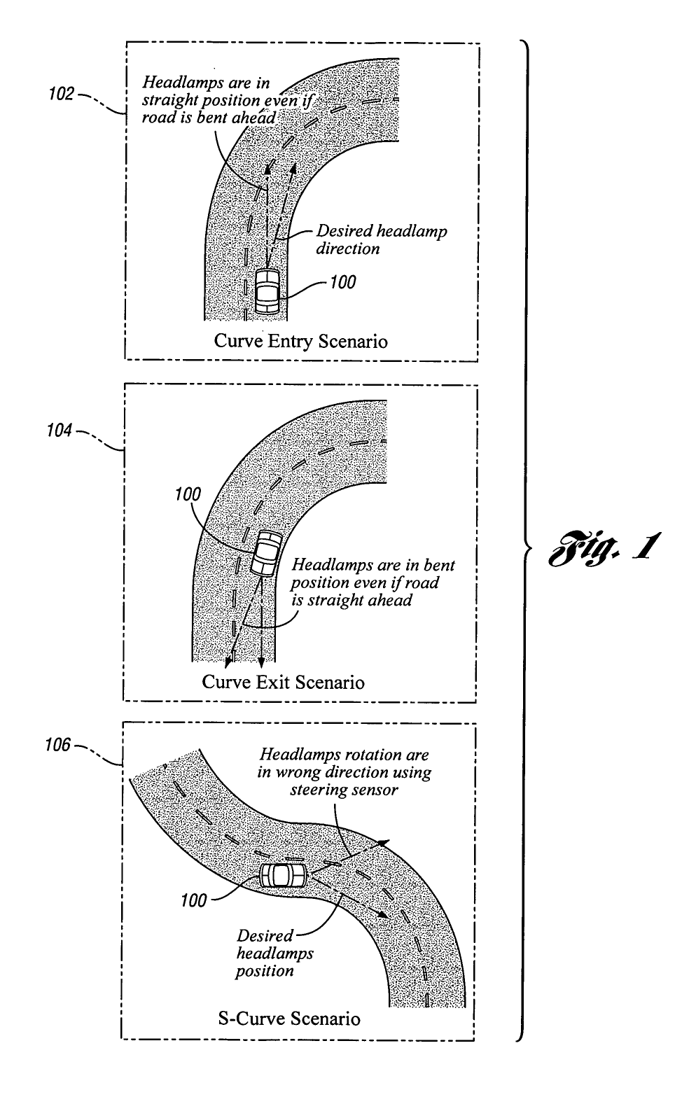

Referring to FIG. 1, there is shown various scenarios typically encountered by a conventional adaptive front lighting system implemented in a vehicle 100. In general, these systems fail to adequately swivel the headlamps in the desired direction. For instance, in a curve entry scenario 102, even though it is desirable that the headlamps start to swivel ahead of the curve to minimize glare to the oncoming traffic and to improve the visibility of the curve ahead of the vehicle 100, conventional adaptive front lighting systems keep the headlamps pointing straight ahead. That is, the headlamps are not swiveled even if the road ahead of the vehicle 100 is curved. The headlamps are eventually swiveled, but as the vehicle 100 exits the curve as shown at 104, the headlamps remain in a swiveled position rather than pointing straight ahead as the road becomes straight.

In an S-curve scenario, shown at 106, it is desirable that the headlamps start to swivel before the vehicle 100 enters the saddle point so that the headlamps point in the direction of the upcoming curve. However, with conventional adaptive front lighting systems, the headlamps are typically pointing in the wrong direction as the vehicles maneuvers through an S-curve.

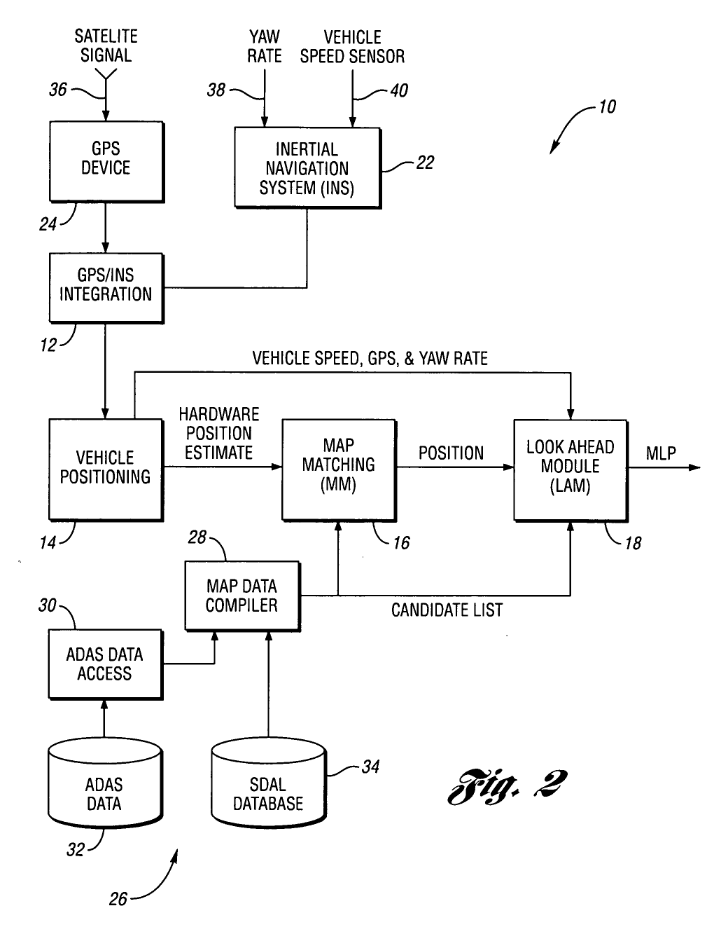

Referring now to FIG. 2, a system 10 embodying the principles of the present invention provides vehicles with the capability to predict changes in road geometry. As its primary components, the system 10 includes a global positioning system (GPS) and inertial navigation system (INS) integration module 12, a vehicle positioning module 14, a map matching module 16, a look ahead module 18, and a curve speed warning module 20. The system 10 is also provided with an inertial navigation system 22, a GPS receiver 24, a map database 26, and yaw rate and vehicle speed sensors. The map database 26 includes a map data compiler 28 and an ADAS data access 30 that receives information from an ADAS data base 32. The map data complier 28 also receives information from an SDAL database 34. The map database may be a database that is commercially available.

The GPS receiver 24 receives satellite information 36 related to the vehicle GPS position. In the GPS/INS integration module 12, the GPS position is augmented using, for example, a Kalman filter, with the yaw rate 38 and the vehicle speed 40 obtained through the inertial navigation system 22. The information from the GPS/INS integration module 12 is provided to the vehicle positioning module 14, where the vehicle position is calculated in a global coordinate system.

The map matching module 16, implemented with a map matching algorithm, receives the hardware position estimate from the vehicle positioning module 14 and information from the map database 26 to calculate the vehicle position on the map. The look ahead module 18 then receives the map position information from the map matching module 16, as well as information from the vehicle positioning module 14 and the map database 26, and looks ahead in the map from the calculated map position and calculates the candidate list of probable intended driving paths, in particular, a most likely path based on various probabilities.

Specifically, the look ahead module 18 determines the most probable path and other alternate paths of the vehicle employing, for example, information from vehicle positioning, lane information, lateral velocity, and vehicle signals, such as turn and brake signals, lane information, and various states of the vehicle. This information can be evaluated using a cost function to weigh each parameter with respect to the consideration that the parameter will have toward predicting the vehicle's most probable path (MLP).

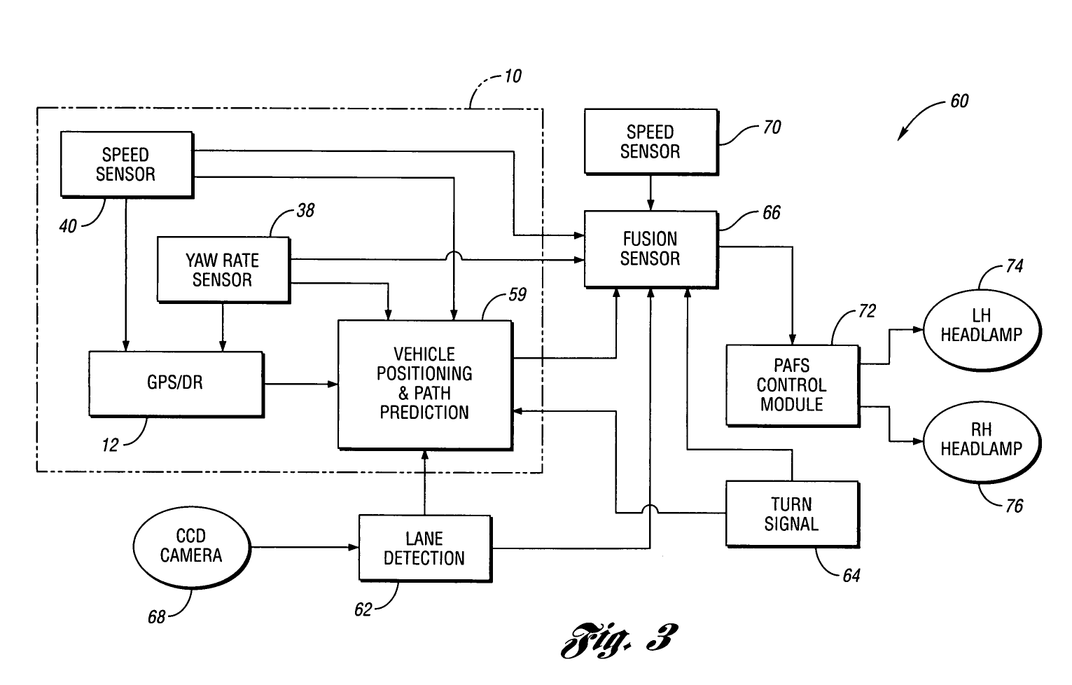

Referring to FIG. 3, in accordance with the invention, the aforementioned system 10 is incorporated into a predictive adaptive front lighting integrated system 60 to swivel the headlamps 74, 76 of a vehicle as the vehicle maneuvers along a road so that the headlamps aim in a desired direction to increase the driver's visibility of the road. Note that in FIG. 3, the vehicle positioning module 14, the map matching module 16, the look ahead module 18, the map database 26 and the various modules and data associated with the map database 26 of the system 10 are collectively shown as a vehicle positioning and path prediction module 59 in FIG. 3.

The predictive adaptive front lighting integrated system 60 includes a lane detection module 62, which receives road scene images from a forward-looking camera 68 to detect, track, and recognize lane boundaries. The lane boundary information is passed to the vehicle position and path prediction module 59 to help in determine the most likely path. Further, the lane detection module 62 detects lane changes and calculates vehicle position and orientation with respect to lane markings, and a curvature calculation algorithm implemented in the lane detection module 62 calculates the curvature of the road ahead of the vehicle. The curvature, position, and orientation data are passed with their associated confidence to the fusion module 66. The vehicle positioning and path prediction module 59 may also receive curvature information from the lane detection module to determine the most likely path.

In a particular implementation, the fusion module 66 performs three integration operations. First, by employing two parameters, the module 66 integrates curvature data of upcoming curves provided by the vehicle positioning and path prediction module 50 and the lane detection module 62. The first parameter is the confidence level associated with the curvature data provided by the path prediction module 50 and the confidence level associated with the curvature data provided by the lane detection module 62. The second parameter is employed to compare the calculated yaw rate based curvature (instantaneous curvature) using information from the yaw rate sensor 38 with the first curvature point (that is, the curvature value the closest to the vehicle) generated from each source. This comparison is performed only when a high confidence is associated with the yaw rate based curvature, which can be achieved by filtering the data measured when the vehicle is not following the tangent of the road. Vehicle orientation and lane change data from the lane detection module can be employed for filtering. At the completion of this function, the fusion module 66 has curvature values with a particular level of confidence over a desired distance ahead of the vehicle.

The second integration operation of the fusion module 66 uses the data from the lane detection module 62 to establish a confidence level associated with the steering angle and vehicle speed data provided by a steering sensor 70 and the speed sensor 40. (Recall that steering angle and vehicle speed data is all that is typically used by conventional adaptive lighting systems to swivel the headlamps.) As such, whenever the vehicle makes a lane change, the steering angle measurement is not associated with changes in the road geometry, and as a result the confidence level associated with the steering angle data is low. Also, whenever the jitter in the steering angle is high while the vehicle moves along a straight road, the confidence is low.

Accordingly, after the completion of the second operation, the fusion module has two sets of data: (1) steering angle and vehicle speed data and their associated confidence level; and (2) predictive curvature data with its associated confidence. In the third integration operation, the fusion module 66 then integrates the two sets of data, since data set (1) provides data associated with the current vehicle position and data set (2) contains both data associated with the vehicle position and data associated with the road ahead of the vehicle.

Therefore, in sum, the fusion module 66 provides integrated data of the road near the vehicle based on the confidence level of the data, determines a balance between the weight of the data associated with the road ahead of the vehicle and data associated with the road near the vehicle based on the confidence level of the predictive data and the road geometry, and employs the vehicle position and orientation with respect to current lane to modify the final calculated swiveling angle of the headlamps 74 and 76. The fusion module 66 then passes the final calculated swiveling angle to a control module 72, which swivels the left headlamp 74 and the right headlamp 76 over the calculated swiveling angle so that the headlamps aim in the desired direction to improve the driver's visibility of the road.

In certain implementations, the predictive adaptive front lighting integrated system 60 includes a turn signal module 64 that provides turn signal data to the fusion module 66 and the vehicle positioning and path prediction module 59. This data may be used to on left or right auxiliary lights. In addition, data from the turn signal module may protect against errors associated with the map matching process or the determination of the most likely path. For example, if the direction of the most likely path contradicts the turn signal data, then the system 60 prevents the headlamps 74 and 76 to swivel in the direction of the most likely path.

As a person skilled in the art will readily appreciate, the above description is meant as an illustration of an implementation of the principles of this invention. This description is not intended to limit the scope or application of this invention in that the invention is susceptible to modification, variation and change, without departing from the spirit of this invention, as defined in the following claims.

What is claimed is:

1. An adaptive front lighting system for aiming headlamps of a vehicle to illuminate the roadway ahead of the vehicle comprising:
a navigation system that determines the curvature of the road ahead of the vehicle; and
a control module that receives information about the curvature of the road ahead of the vehicle and instructs the headlamps to swivel over a swivel angle to illuminate the roadway ahead of the vehicle.

2. The system of claim 1 further comprising a fusion module that processes the curvature information from the navigation system, calculates the swivel angle for the headlamps, and transmits the calculated swivel angle to the control module.

3. The system of claim 2 further comprising a lane detection module that detects, tracks, and recognizes lane boundaries and passes this information to the navigation system to aid determining a most likely path of the vehicle.

4. The system of claim 3 wherein the lane detection module is implemented with a curvature calculation algorithm to calculate the curvature ahead of the vehicle.

5. The system of claim 3 wherein the lane detection module detects lane changes and calculates vehicle position and orientation with respect to lane markings.

6. The system of claim 3 further comprising a camera that transmits road scene images to the lane detection module.

7. The system of claim 1 wherein the fusion module determines the curvature values of the road ahead of the vehicle with a particular level of confidence.

8. The system of claim 1 wherein the navigation system includes a vehicle positioning and path prediction module that communicates with the fusion module, the vehicle positioning and path prediction module determining the vehicle's position in a global positioning system, determining the vehicle's position on a map based on the position in the global positioning system, and looking ahead on the map for curves and determining the most likely path through the curves.

9. The system of claim 8 further comprising a yaw rate sensor that transmits the vehicle's yaw rate to the fusion module and the vehicle positioning and path prediction module and a vehicle speed sensor that transmits the vehicle's speed to the fusion module and the vehicle positioning and path prediction module.

10. The system of claim 9 further comprising a steering angle sensor that transmits the angle of the steering angle of the vehicle's wheels to the fusion module.

11. A method for aiming headlamps of a vehicle to illuminate the roadway ahead of the vehicle comprising:
determining the curvature of the road ahead of the vehicle with a navigation system; and
receiving information about the curvature of the road ahead of the vehicle with and control module and instructing the headlamps to swivel over a swivel angle to illuminate roadway ahead of the vehicle with the control module.

12. The method of claim 11 further comprising processing the curvature information from the navigation system with a fusion module, calculating the swivel angle for the headlamps with the fusion module, and transmitting the calculated swivel angle from the fusion module to the control module.

13. The method of claim 12 further comprising detecting, tracking, and recognizing lane boundaries and passing this information to the navigation system to aid determining a most likely path of the vehicle.

14. The method of claim 13 further comprising transmitting road scene images from a camera to the lane detection module.

15. The method of claim 11 further comprising determining the curvature values of the road ahead of the vehicle with a particular level of confidence.

16. The method of claim 11 further comprising determining the vehicle's position in a global positioning system, determining the vehicle's position on a map based on the position in the global positioning system, and looking ahead on the map for curves and determining the most likely path through the curves.
